(19) United States
(12) Patent Application Publication
(10) Pub. No.: US 2005/0030766 A1
(43) Pub. Date: Feb. 10, 2005

(54) Lighting apparatus

(76) Inventors: Phil A. Markey, Duncraig (AU); Joe M. Dietrich, East Victoria Park (AU)

Correspondence Address: ALLEN, DYER, DOPPELT, MILBRATH & GILCHRIST, PA, P.O. BOX 3791, ORLANDO, FL, 32802-3791, US

(21) Appl. No.: 10/881,321

(22) Filed: Jun. 30, 2004

Related U.S. Application Data
(63) Continuation-in-part of application No. 10/731,880, filed on Dec. 9, 2003.
Application No. 10/731,880 is a continuation-in-part of application No. 10/070,494, filed on Jun. 14, 2002, now Pat. No. 6,659,626.

(30) Foreign Application Priority Data
Sep. 7, 1999 (AU) 47417/99

(51) Int. Cl. F21V 3/00

(52) U.S. Cl. 362/583

(57) ABSTRACT

A lighting system 10″ comprises a plurality of arms 12 each of which support a plurality of optical fibre strands 14. The arms 12 are retained by a housing part 28b which is able to rotate relative to the housing part 28a. A length 20 at a distal end of each strand 14 extends from its corresponding arm 12 and is able to freely move. The arms 12 are rotated about their respective longitudinal axes by a transmission system 22 which receives drive from a motor 110 located in the housing part 28a. A lighting system 112 produces light of remotely controllable variable wavelength which is channelled through the optical fibre strands 14. By the use of a hand-held remote transmitter, the user is able to select a desired wavelength or combination of wavelengths of light to be emitted by the lighting system 112. As the arms 12 rotate about their lengths, and the housing part 28b rotates relative to the housing part 28a, the lengths 20 of the fibres 14 move in a random and erratic fashion through the air producing an erratic lighting effect.

### CROSS-REFERENCE TO RELATED APPLICATIONS

This application is a continuation-in-part and incorporates by reference co-pending application Ser. No. 10/731,880, filed Dec. 9, 2003, which is a continuation-in-part of and incorporates by reference application Ser. No. 10/070,494, filed Jun. 14, 2002, now U.S. Pat. No. 6,659,626, which is a 371 of PCT/AU00/01061, filed Sep. 7, 2000, which claimed priority to Australian Application No. 47417/99, filed Sep. 7, 1999, which are commonly owned with the present invention and which is incorporated herein by reference.

### FIELD OF THE INVENTION

The present invention relates to a lighting apparatus.

### BACKGROUND OF THE INVENTION

Many different types of lights and lighting apparatus are currently available. Largely, these are designed to specifically illuminate an area as distinct from providing some type of visual effect, although illumination is also possible. Embodiments of the present invention are concerned with providing an unusual visual effect. Currently available lights and lighting apparatus that produce unusual effects include LAVA LAMPS and fibre optic lamps. The lava lamp has a clear glass body filled with a carrier liquid and large globules of a second liquid. The second liquid is heated by a light source channelled though the carrier liquid and moves in a random fashion through the carrier liquid. This provides a moving light effect while the lamp itself remains stationary. Common fibre optic lamps comprise in general a light source and a bundle of optical fibre strands emanating from that source. The fibres can be moved by hand or by air currents although the lamp itself again remains stationary.

### SUMMARY OF THE INVENTION

It is an object of the present invention to provide an alternate form of lighting apparatus that can produce an erratic or random lighting effect.

According to the invention there is provided a lighting apparatus comprising:
a light system producing light of remotely controllable variable wavelength;
a controller coupled to said light system which receives signals from a remote device to vary the wavelength of light emitted by said light system;
at least one support member;
a housing containing said light system and to which said at least one support member is rotatably coupled;
a plurality of optical fibre strands supported by respective support members, each strand having a proximal end receiving light from said light system and a length at a distal end extending from its respective support member;
a motor supported by said housing; and, a transmission system for imparting motion to said support members from said motor to cause said support members to rotate about one or both of respective first axes that extend collinearly with the length of each of said support members and a common second axis, said second axis being non-coincident with at least one of said first axis.

Preferably said light system further comprises a plurality of multi-coloured light emitting devices which, when in an ON condition emit light having one of a plurality of wavelengths.

Preferably each light emitting device is a multi-coloured light emitting diode.

In an alternate embodiment said light system comprises:
a light source;
a multi-coloured filter through which light from said light source must pass prior to entering said optical fibre strands, said multi-coloured filter having a plurality of sections which filter different wavelengths of light; and,
a positioning motor for positioning selected sections of said multi-coloured filter in an optical path between said light source and said optical fibre strands.

Preferably said sections are arranged so that at any time the filtered wavelength of light entering all of said optical fibre stands is the same.

In an alternate arrangement, said sections of said multi-coloured filter are arranged so that at any time the filtered wavelength of light entering at least two of said optical fibres is different.

Preferably said multi-coloured filter comprises a shroud within which said light source is disposed.

Preferably said multi-coloured filter is mounted to rotate relative to said support members.

According to the invention there is also provided a lighting apparatus adapted for connection to a source of rotary motion comprising at least:
a housing containing a light source;
a support member rotatably coupled to said housing;
a plurality of optical fibre strands supported by said support member, each strand having a proximal end adapted to receive light from said light source and a length at a distal end extending from said support member; and,
transmission means for imparting motion to said support member from said source of rotary motion to cause said support member to rotate about one or both of a first axis extending collinearly with the length of the support member and a second non-coincident axis;
whereby, in use, when light from a light source enters said proximal ends of said strands and motion is imparted to said support member, said length at the distal end of said strands move in a random manner to produce an erratic lighting effect.

Preferably said lighting apparatus includes a plurality of support members each rotatably coupled to said housing about respective first axes that extend collinear with the length of said support members.

Preferably said transmission means for imparting motion includes a first gear mounted in the housing in a manner so that said first gear can rotate relative to the housing, and a plurality of second gears respective ones of which are coupled to respective proximal ends of each support member and which mesh with said first gear so that rotation of the housing relative to the first gear imparts rotational motion to the support members along said respective first axes.

Preferably said optical fibre strands are arranged in two or more groups of strands of different length with the length at the distal ends of said different groups of strands extending from the support members at different locations.

Preferably the lighting apparatus further includes light filter means for filtering light prior to entering said optical fibre strands.

Preferably the filter means filters the light to produce transmitted light of multiple wavelengths.

Preferably said filter means is mounted to rotate relative to said support members.

Preferably said filter means is in the form of a shroud mounted about said light source.

According to the invention there is also provided a lighting apparatus including at least:
a light source;
at least one support member;
a housing containing said light source and to which said at least one support member is rotatably coupled;
a plurality of optical fibre strands supported by respective support members, each strand having a proximal end adapted to receive light from the light source and a length at a distal end extending from its respective support member;
a motor to provide a source of rotary motion; and
transmission means for imparting motion to said support members from said motor to cause said support members to rotate about one or both of respective first axes that extend collinearly with the length of each support members and a common second axis, said second axis being non-coincident with at least one of the first axes.

Preferably each support member comprises a plurality of arms joined end to end by coupling sleeves for receiving ends of adjacent arms, said sleeves also provided with a plurality of openings through which the length of the distal ends of selected optical fibre strands can extend.

In one form of the invention, the motor is a first of first and second motors and the housing comprises first and second parts that can rotate relative to each other, the first and second motors being independently controlled, the first motor providing drive through the transmission system to rotate the support members about their first axes, and the second motor providing drive through the transmission system to rotate the second part of the housing relative to the first part of the housing.

Preferably the transmission system comprises a first gear and respective second gears coupled to each of the support members, the first gear meshing with each of the second gears and wherein the first motor, when in an energised state, imparts drive to the first gear to cause the support members to rotate about their respective first axes.

Preferably the transmission system comprises a drive element coupled to the second part and wherein the second motor, when in an energised state, imparts drive to the drive element to cause a second part to rotate about a second axes relative to the first part.

Preferably when the first motor is in a de-energised state the first motor rotationally fixes the first gear to the first part of the housing whereby rotation of the first part of the housing relative to the second part of the housing also imparts drive to the second gears to cause the support members to rotate about both their respective first axes, and the second axis.

In one embodiment, the apparatus further comprising a third motor supported by the housing and the light system comprises a light source, and a multi-coloured filter through which light from the light source must pass prior to entering the optical fibre strands, the multi-coloured filter having a plurality of sections which filter different wavelengths of light; wherein the third motor is coupled to the multi-coloured filter to position selected sections of the multi-coloured filter in an optical path between the light source and the optical fibre strands.

Preferably the third motor has a controllably variable speed.

In a further variation, the lighting apparatus further comprises one or more auxiliary support arms, each auxiliary support arm rotationally coupled to the second part and extending in a direction parallel to the second axis, each auxiliary support arm supporting a plurality of optical fibre strands, each optical fibre strand having a proximal end receiving light from the light system and a length at a distal end extending from its respective auxiliary support member.

Preferably the transmission system imparts drive to the auxiliary arms to cause them to rotate about corresponding respective longitudinal axes of each auxiliary arm.

According to the present invention there is further provided a lighting apparatus comprising:
a light system producing light of remotely controllable variable wavelength, the light system receiving signals from a remote device to vary the wavelength of light emitted by the light system;
at least one first support member, each first support member having a longitudinal first axis;
a housing comprising first and second parts where the second part can rotate about a second axis relative to the first part, the housing containing the light system and rotatably supporting each of the first support members;
a plurality of optical fibre strands supported by respective first support members, each strand having a proximal end receiving light from the light system and a length at a distal end extending from its respective first support member; and,
first and second independently controllable motors, the first motor coupled to the first support members to impart drive to the first support members causing them to rotate about their respective first axes, and the second motor coupled to the second part of the housing to cause the second part of the housing to rotate about the second axis relative to the first part of the housing.

Preferably the lighting apparatus comprising a transmission system including a first gear rotationally fixed to the first part of the housing and, respective second gears coupled to each first support member, the first gear meshing with each of the second gears whereby rotation of the second part of the housing relative to the first part of the housing causes the first support arms to rotate about their respective first axes.

### BRIEF DESCRIPTION OF THE DRAWINGS

Embodiments of the present invention will now be described by way of example only with reference to the accompanying drawings in which:

FIG. 1 is a plan view of a lighting apparatus in accordance with one embodiment of the present invention;

FIG. 2 is a side elevation view of the lighting apparatus when attached to an electric fan;

FIG. 3 is a section view of the lighting apparatus when opened;

FIG. 4 is a plan view of the lighting apparatus with its housing open;

FIG. 5 is a section view of a support member incorporated in the lighting apparatus;

FIG. 6 illustrates a coupling for coupling the lighting apparatus to a fan;

FIG. 7 is a representation of a second embodiment of the lighting apparatus;

FIG. 8 is a cut-away perspective view of a third embodiment of the lighting apparatus;

FIG. 9 is a cut-away perspective view of a fourth embodiment of the lighting apparatus;

FIG. 10 is a cut-away perspective view of a fifth embodiment of the lighting apparatus; and,

FIG. 11 is a cut-away perspective view of a sixth embodiment of the lighting apparatus.

### DETAILED DESCRIPTION OF THE PREFERRED EMBODIMENTS

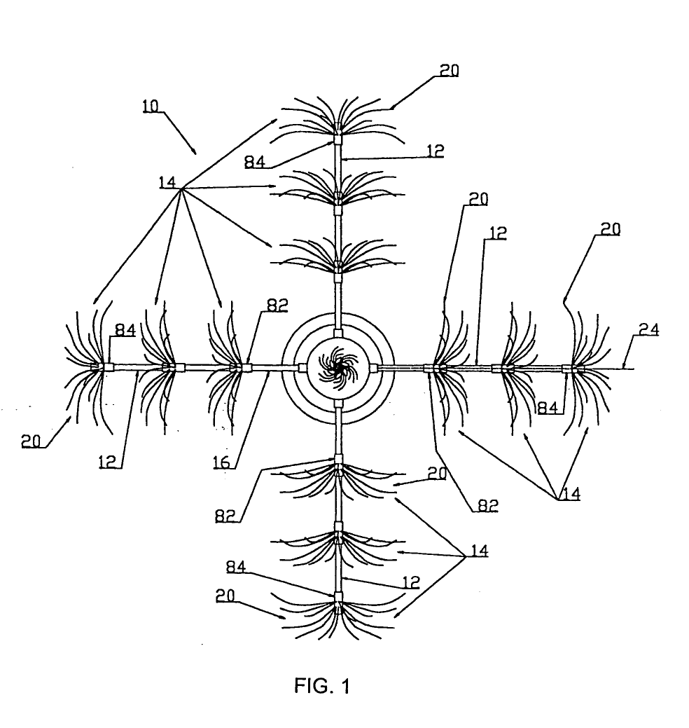

Referring to FIGS. 1-4 of the accompanying drawings, lighting apparatus 10 comprises at least one (in this instance four) support members or arms 12. A plurality of optical fibre strands 14 are supported by each support member/arm 12. Each strand 14 has a proximal end 15 adjacent proximal end 16 of its corresponding arm 12 that is adapted to receive light from a light source 18. A length 20 at the distal end of each strand 14 extends from its corresponding arm 12. The lighting apparatus 10 also includes a transmission 22 for imparting motion to the arms 12 to cause them to rotate about one or both of a first axis 24 that extends collinearly with the length of the respective arms 12, and a second non-coincident axis 26. In this particular embodiment the second axis 26 extends perpendicular to the first axis 24, however, as explained below, this need not be the case. Thus, in use, when light from the light source 18 enters the proximal ends 15 of the fibre strands 14 and motion is imparted to the arms 12, the arms 12 rotate about their respective axes 24 and simultaneously rotate about the axis 26. This causes the length 20 of the fibres 14 to move in a random and erratic fashion through the air thus providing the erratic lighting effect.

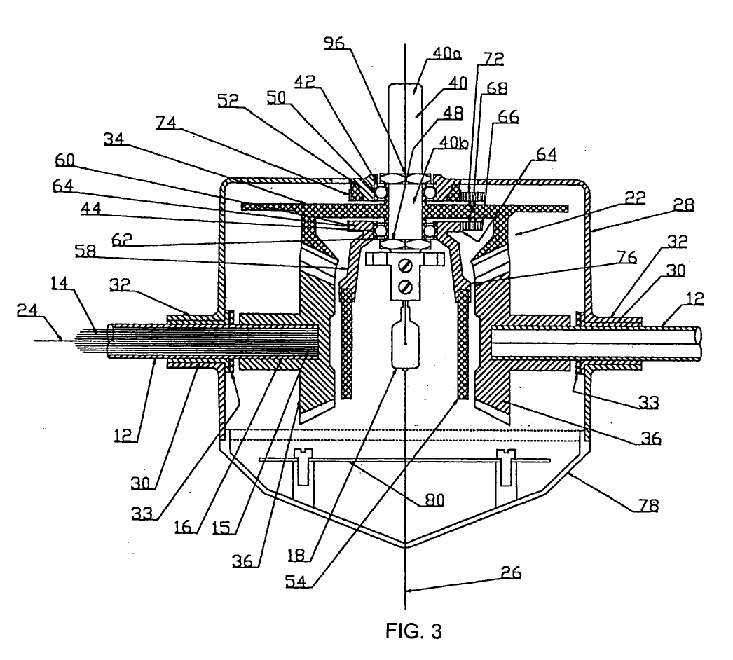

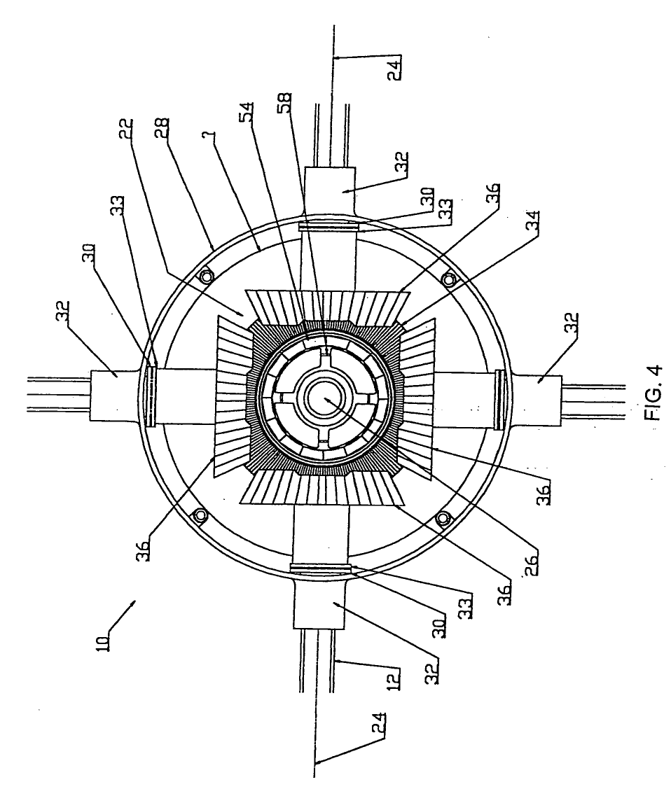

Looking more closely at the components of the lighting apparatus 10, it can be seen that the fitting 10 includes an outer housing 28. The housing 28 rotatably supports the arms 12 and houses the light source 18 and the transmission 22. Referring to FIGS. 3 and 4, it can be seen that the proximal end 16 of each arm 12 is held with a bearing bush 30 that in turn is retained within a corresponding radially extending socket 32 formed integrally with the housing 28. An annular circlip 33 is seated in a circumferential groove (not shown) formed about the proximal end 16 of each arm 12 radially inward from bush 30 to prevent the arms 12 from being pulled out of the housing 28.

The transmission 22 comprises a first gear 34 and a plurality of second gears 36 that mesh with the gear 34. The first gear 34 is fixed to a stationary short hollow shaft 40 that extends along the axis 26 and has an upper portion 40a that is outside the housing 28 and a lower portion 40b that is inside the housing 48. The first gear 34 is fixed to the lower part of the shaft 40b between two bearings 42 and 44, each of which has an inner race that is fixed to the shaft 40. The gear 34 and bearings 42 and 44 are prevented from axial motion along the shaft 40 by being clamped between nuts 46 and 48 each of which engages a thread (not shown) formed on the outer circumferential surface of the shaft 40. The housing 28 is fixed to outer race 50 of the bearing 42. More particularly, the outer race 50 is seated within an inwardly protecting boss 52 formed about axis 26 on the inside of housing 28. By virtue of this coupling it will be appreciated that with the shaft 40 held stationary, the housing 28 can rotate about axis 26 relative to the gear 34 which remains stationary with the shaft 40.

Each gear 36 is fixed to the proximal end 16 of a respective arm 12. The gears 36 are ranged to rotate about axes 24 that are perpendicular the axis 26. Due to the meshing of gears 34 and 36, as the housing 28 rotates relative to the first gear 34, the arms 12 are also caused to rotate about the respective axes 24. When the fitting 10 is attached to a ceiling fan F, the housing 28 is attached to a rotating part of the fan while the shaft 40 would be coupled to a stationary axle of the fan. Electric wire's (not shown) are fed through the shaft 40 to provide electrical power to the light source 18.

Typically the light source 18 is a low voltage (eg 12V) light globe radiating white light. However to increase the visual appeal produced by the fitting 10 a filter 54 is placed between the light 18 and the proximal ends 15 of the fibres 14 so that the distal ends of the fibres 14 can emit light of colour or wavelength other than white. The filter 54 is in the form of a cylindrical shroud 56 that surrounds the light 18 and is supported on a driven holder 58. The holder 58 has an annular flange 60 at an upper end through which the shaft 40 passes. More particularly, outer race 62 of bearing 44 is fixed to a central hole in the flange 60 through which the shaft 40 extends. An outer circumferential surface of the flange 60 is formed with gear teeth 64 that mesh with a gear wheel 66 of a dumbbell shaped gear 68. The dumbbell gear 68 has a shaft 70 extending axially from the gear wheel 66 through the gear 34 and attached at its opposite end to a gear wheel 72. The gear wheel 72 meshes with a gear 74 formed about the outer circumferential surface of the boss 52. Gear wheels 66 and 72 are arranged to have a different diameter and, in this particular embodiment, the gear wheel 66 has a smaller diameter than the gear wheel 72. As the housing 28 rotates about shaft 40, torque is transmitted via the gears 74, 72 and 66 to the holder 58. According the filter 54 also rotates about the axis 26. Because of the difference in the diameter of the gears 72 and 66, the filter 54 rotates more quickly than the housing 28. More particularly, by virtue of this arrangement, there is relative rotation between the filter 54 and the proximal ends 15 of the fibres 14. Thus, by forming the filter 54 as a plurality of panels of different colour the wavelength of the light emitted by the fibres 14 will be seen to change in time.

The filter 54 is held conveniently by an interference or snap fit into an annular groove 76 formed at a depending end of the holder 58. This allows for convenient and easy interchanging of filters 54 to produce different visual effects.

The housing 28 is provided with a clip on.—clip off lower cap 78. The clip on—clip off characteristic can be provided by any known technique such as by providing mating annular grooves and protrusions. By making the caps 78 of clear or translucent material, the fitting 10 can also provide “white” downlighting. A standard diffuser screen or disc 80 is mounted on the inside of the cap 78 below the light 18 to further assist in dispersing white light in a downward direction.

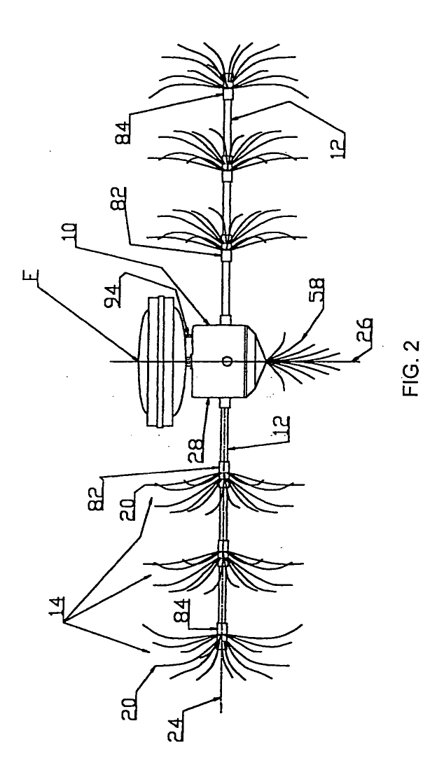

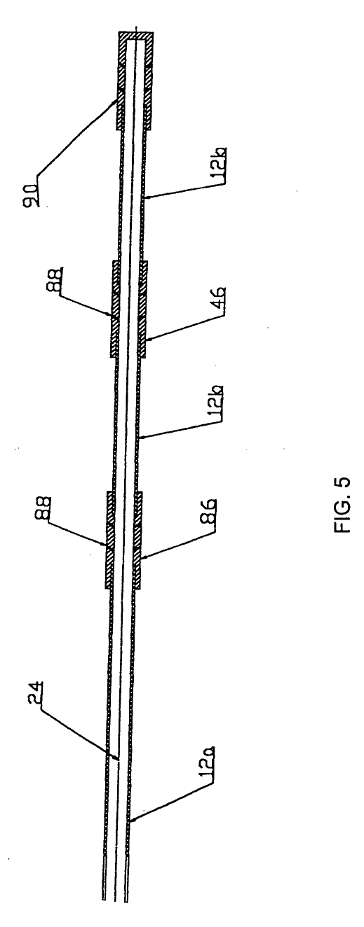

As shown in FIGS. 1 and 2, the optical fibres 14 are arranged in groups of different lengths. In this way, the length 20 at the distal end of each group of strands is able to exit the arms 12 at different locations. In this embodiment, the fibres are arranged in two different groups so that they emanate from the arms 12 at different locations 82 and 84. This can be achieved by providing openings in the arms 12 through which the lengths 20 are passed. However to simplify the manufacture, as shown in FIG. 5, each arm 12 can be made from a plurality of short lengths 12A and 12B coupled together by a sleeve 86 that is provided with a plurality of openings or slits 88 through which the lengths 20 can pass. The positioning of the lengths 20 can also be effected by forming the slits 88 at an acute angle or having some of the slits 88 arranged at different acute angles.

An end sleeve 90 is provided at the distal end of arm 12 and is similarly provided with slits 88 through which the lengths 20 of the second group of strands can pass.

It is envisaged that the arms 12, (including lengths 12A, 12B) as well as the sleeves 86 and 90 will be made from an opaque material. A particularly well suited material would be aluminum tubing. In this manner, the light would emanate only from the distal ends of the lengths 20 of the strands 14.

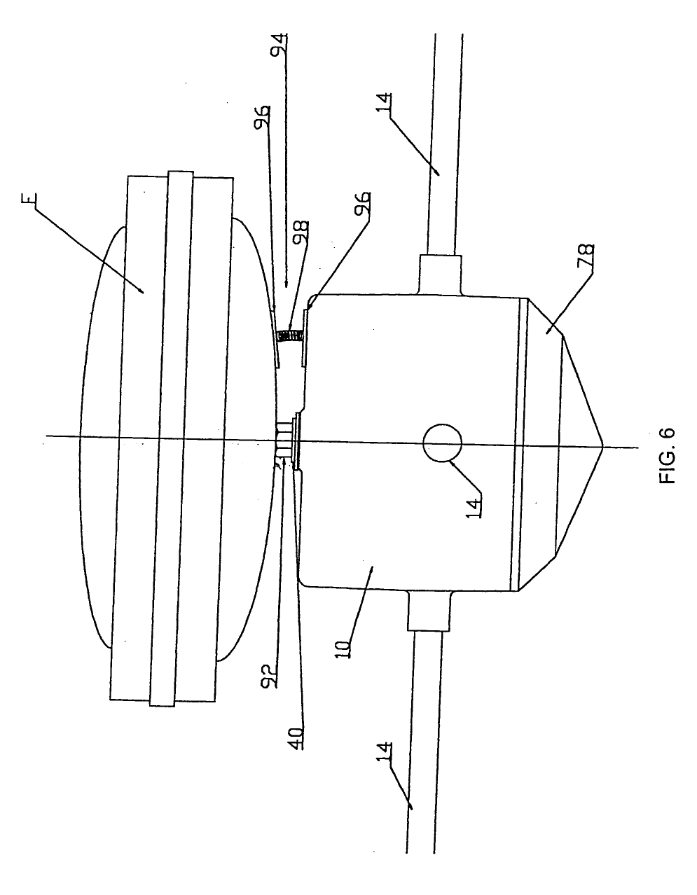

FIG. 6 illustrates how a fitting 10 is attached to a rotating motor of a fan F. The motor of the fan F generally has a fixed axle or another stationary fixing point to which the shaft 40 can be attached by way of a threaded sleeve 92. By this coupling, the shaft 40 is held stationary. In order to impart rotational motion to the housing 28, the coupling between the fitting 10 and the fan F also includes a resilient coupling 94. In this embodiment the resilient coupling 94 includes a pair of stick-on plates 96 of each being stuck to the outside of the housing 28 and the fan F in a mutually opposing juxtaposition, and a spring 98 which is coupled at its opposite ends the respective ones of the plates 96. This can be achieved by providing a small hole 100 in each plate 96 into which opposite ends of the spring 98 can be inserted with an interference fit.

When the fan F is operated so that its outer housing rotates, the rotational motion is transferred via the coupling 94 to the housing 28. Not only is the coupling 94 resilient but it is also frangible so that if the arms 12 is an obstacle (such as a child's arm) the coupling 94 can be broken by the spring 98 pulling out of one or both of the plates 96 thus decoupling torque from the fan F to the housing 28. The coupling 94 can be easily reinstated by simply inserting opposite ends of the spring 98 back into the holes 100 of the plates 96.

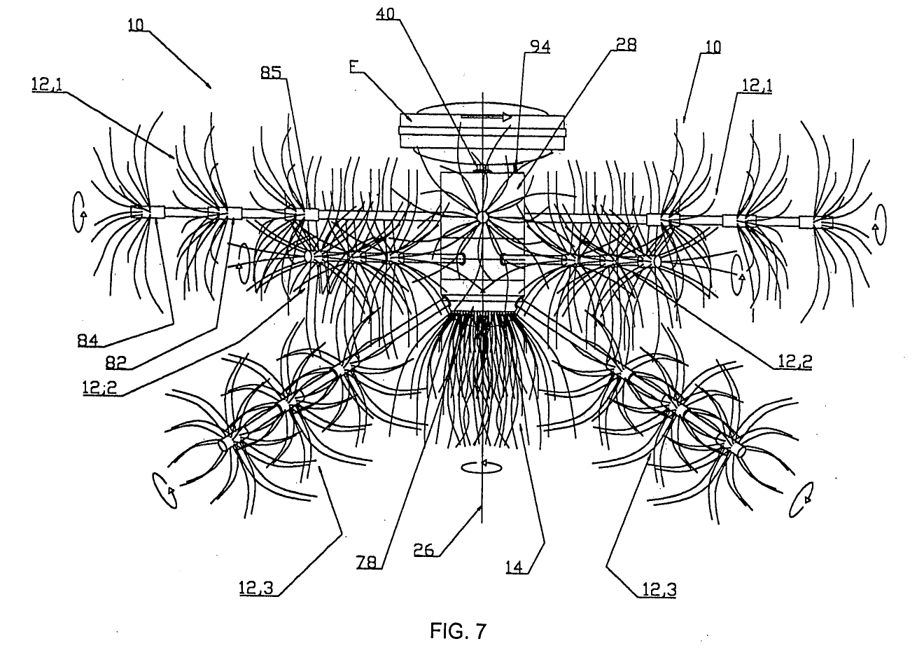

FIG. 7 illustrates a further embodiment of the lighting apparatus 10′ having a plurality (three) tiers or layers of arms 12₁, 12₂ and 12₃. To accommodate the three tiers of arms 12₁-12₃ the housing 28 is extended in its axial length. The first tier of arms 12, are arranged in an identical manner to the arms 12 depicted in FIGS. 1-5. The second tier of arms 12₂ are arranged in a like fashion to the first tier 12₁ but are off set about axis 26 by 30 relative to arms 12₁. The arms 122 are provided at their proximal ends with gears (not shown) that mesh with gears 36 of arms 12, to provide rotational motion to arms 12₂. However, the gearing of arms 12₂ can be arranged so that they rotate in the opposite direction to arms 12₁.

The third layer or tier of arms 12₃ extend at an acute angle to both the axis 26 and the axes 24 of the arms 12₁, 12₂. Arms 12₃ also rotate about selective axes coincident with their length by way of similar gearing arrangement to arms 12₁ and 12₂. The arms 12₃ are offset by a further 30 about axis 26 so that angularly there is one arm 12₂ and one arm 12₃ between adjacent arms 12₁.

Further, in the lighting apparatus 10′ the fibres 14 held in any one of the arms 12₁-12₃ are arranged into three groups so as to emanate from the arms at three different locations, 82, 84 and 85. Additionally the end caps 78 is provided with a plurality of downwardly depending fibres 14′.

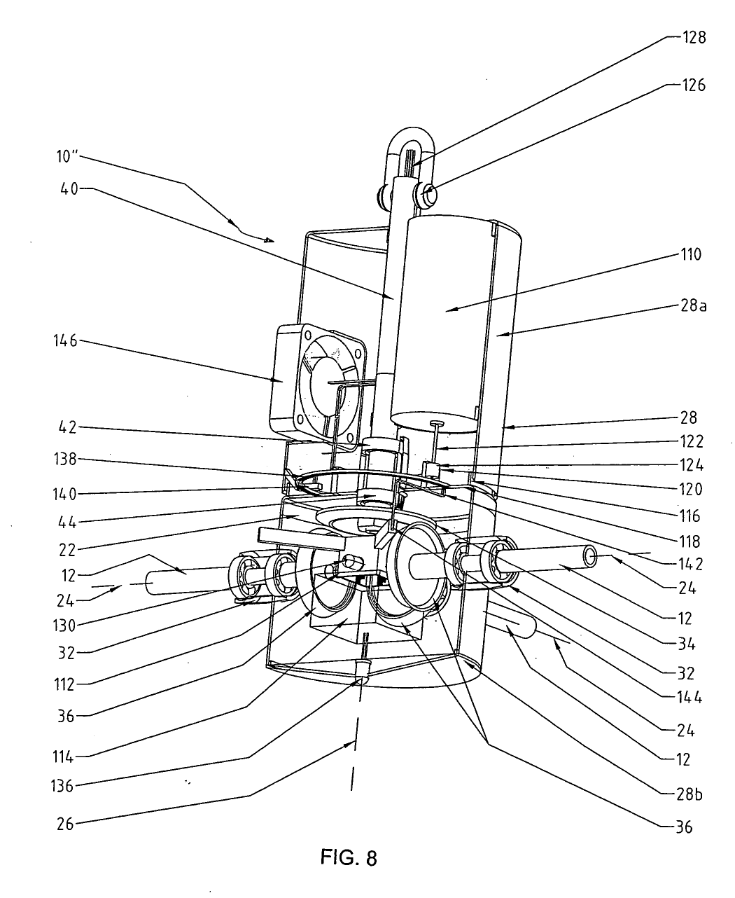

FIG. 8 illustrates a further embodiment of the lighting apparatus 10″ in which similar features are denoted by the same reference numbers.

The main differences between the lighting apparatus 10″ and the apparatus 10 and 10′ are: the forming of the housing 28 as two separate housing parts 28a and 28b; the inclusion of a motor 110 within the housing 28 to impart rotary motion to the support members 12; the provision of the lighting system 112 which produces light of remotely controllable variable wavelength; and, an associated controller 114 for receiving signals from a remote device to vary the wavelength of light transmitted by the lighting system 112.

Looking at the lighting apparatus 10″ in more detail, the housing 28 comprises an upper cylindrical portion 28a and a lower cylindrical portion 28b. The portions are arranged co-axially and rotatable relative to each other. A peripheral skirt 116 is formed on an upper wall 118 of the cylindrical portion 28b and extends axially and inside of a lower end of the cylindrical portion 28a. The skirt 116 covers a gap between the cylindrical portions 28a and the upper wall 118 of the cylindrical portion 28b. An annular wall 120 is also formed co-axially with the cylindrical portion 28b on the upper wall 118 and inside of the skirt 116. This wall is used to impart drive from the motor 110 to the cylindrical portion 28b and, the arms 12 via the transmission system 22. More particularly, the motor 110 rotates a shaft 122 to which is attached a wheel 124 that contacts an outer surface of the wall 120. Thus as the motor turns the shaft 122, the wheel 124 rotates and due to contact with the annular wall 120 turns the cylindrical section 28b relative to the cylindrical portion 28a. The transfer of drive between the wheel 124 and the annular wall 120 may be by way of friction only, for example by forming the wheel 124 as a rubber wheel which is biased into contact with the wall 120; or alternately by a gear system where the wheel 124 is formed as a gear wheel and the annular wall 120 is provided with gear teeth on its outer surface which mesh with the teeth on the wheel 124.

The transmission system 22 in the apparatus 10″ is in substance the same as that described in relation to the earlier embodiments. In particular, the transmission system 22 includes a first gear 34 which is fixed to one end of a stationary shaft 40. An opposite end of the shaft 40 is attached to a bracket 126 enabling attachment of the apparatus 10″ to a wall. Wires 128 carrying electricity for powering the apparatus 10″ enter the housing 28 through the shaft 40. The cylindrical portion 28b of the housing 28 is supported by bearings 42 and 44 mounted on the shaft 40 to enable the portion 28b to rotate relative to the stationary shaft 40 and portion 28a.

Each of the gears 36 of the transmission 22 is fixed to a proximal end 16 of a respective arm 12. Due to the meshing of the gears 34 and 36, as the portion 28b rotates relative to the portion 28a as a result of drive imparted by the motor 110, the arms 12 are caused to rotate about their respective axis 24. In addition, the portion 28b rotates about longitudinal axis 26 of the housing 28. The light source 18 of the apparatus 10 and 10′ is replaced in the present embodiment by the lighting system 112 which is able to provide remotely controllable light of different wavelengths. The lighting system 112 in this embodiment comprises a plurality of multi-coloured light emitting devices in the form of multi-coloured LEDs 130. Each LED 130 is able to emit one of four different wavelengths. A separate LED 130 is provided for each arm 12. The LEDs 130 are mounted on a mounting box 132 which also contains the controller 114 which operates on signals received from a remote device to determine which wavelength of light is emitted by each of the LEDs 130. The controller 114 can be arranged to drive the lighting system 112 so that at any time each LED 130 emits the same wavelength. However the controller 114 may also be arranged to control the lighting system 112 so that at any time at least two of the LEDs 130 are emitting light of different wavelengths. The controller 114 may also be receptive to a signal from the remote device to provide random rhythm control over the LEDs 130 so that they change colour in accordance with the beat of music.

In a further variation from the apparatus 10 and 10′, a separate LED 136 is provided which emits down light from the housing 28. The LED 136 can be controlled by the controller 134 or separately any can provide for example white light when the LEDs 130 are in an OFF condition. Alternately the LED 136 may be a multi-coloured LED in which one of the wavelengths of light transmitted corresponds to white light with the LED 136 being controlled so that white light can be emitted when the LEDs 130 are in either an ON or an OFF condition.

Electrical power for the LEDs 130, 136 and the controller 114 is provided by wire 128 via an electrical contact disc 138 which is fixed to the cylindrical portion 28a. A contact bush 140 provides electrical coupling between an end of some of the wires 128 which extend through the shaft 40 and the contact disc 138. A sliding contact 142 makes contact with an under side of the contact disc 138 and is coupled to a connector 144 for providing power to the LEDs 130, 136 and controller 114.

A fan 146 is mounted within the cylindrical portion 28a of the housing 28 for cooling the motor 110.

Optical fibres (not shown) are held within the arms 12 in the same manner as described in relation to the apparatus 10 and 10′.

In use, the apparatus 10″ is typically fitted to a ceiling (not shown) as a stand-alone item rather than being connected to a fan. The arms 12 and thus the optical fibres carried thereby, are able to rotate about both their respective longitudinal axis 24, and the axis 26 of the housing 28. The colour of light emitted by the optical fibres is dependent upon the colour of light emitted by each of the LEDs 130. The colour of light transmitted by the LEDs 130 is controlled by the controller 114 which receives signals from a remote device. The controller 114 can take the form of a microprocessor which is programmed to drive the lighting system 112 in any one of a variety of ways dependent on the signal emitted by the remote device. The remote device can take the form of a wireless hand-held transmitter emitting radio or infrared frequency signals of a type similar to those used for controlling televisions, VCRs, roller doors, etc.

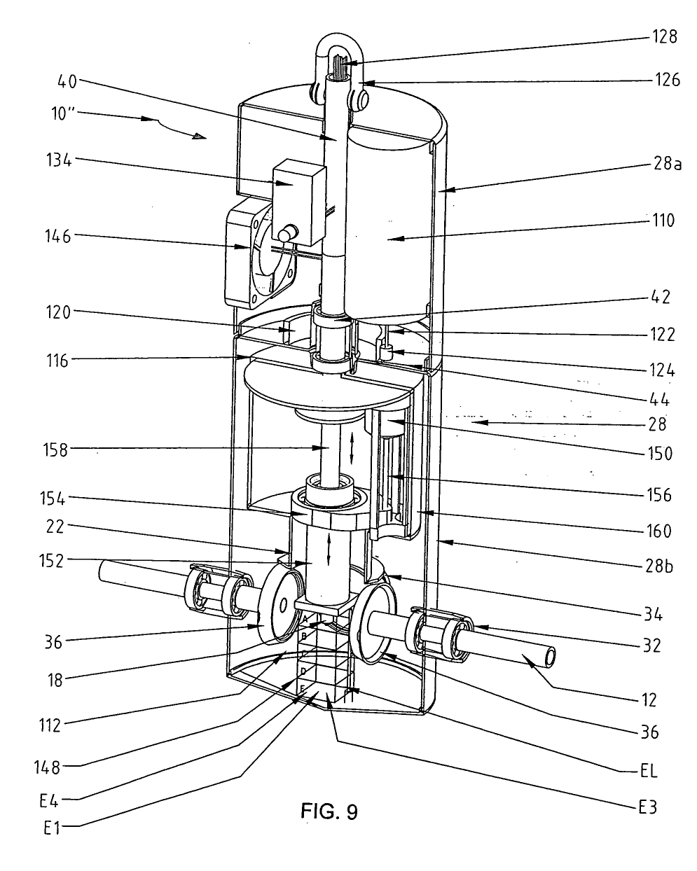

In this instance the controller 114 includes a receiver 133 (shown in FIG. 9) for receiving the radio or infrared signals. Alternately the remote device may be a lighting console connected to the controller 114 by a cable. In this instance the apparatus 10″ may include a lug or connector (shown in phantom as item 133′ in FIG. 9) for coupling to a network lighting console operating under the DMX standard.

FIG. 9 depicts the fourth embodiment of the lighting apparatus 10′″ which, like the apparatus 10″, has a lighting system 112 producing light of remotely controllable variable wavelength although of different construction. In the lighting apparatus 10′″ the housing 28 is composed of coaxially arranged cylindrical portions 28a and 28b which are rotatable relative to each other, and motor 110 for rotating the cylindrical portion 26b relative to the portions 28a, and imparting drive to the transmission system 22. The housing 28a also contains a fan 146 for cooling the motor 110.

The substantive difference between the apparatus 10″ and the apparatus 10′ is in the form of the lighting system 112. In the apparatus 10′″, the lighting system 112 comprises a light source 18 of white light, and a multi-coloured filter 148 in which the light source 18 is disposed. Moreover, the multi-coloured filter 148 is arranged so that light emitted from the light source 18 must pass through the filter 148 prior to entering the optical fibres (not shown) held within the arms 12. The lighting system 112 includes a stepper motor 150 for axially moving a sleeve 152 which in turn carries the filter 148 and light source 18. The sleeve 152 is attached by a bracket 154 to a shaft 156 of the motor 150. The sleeve 152 is also slidably mounted on a post 158 which is coaxial with the shaft 40. The controller 114 receives signals from a remote device to control the stepper motor 150 to cause the shaft 156 and thus the sleeve 152 and multi-coloured filter 148 to move axially up or down. The multi-coloured filter 148 is formed from a plurality of sections A-E which filter different wavelengths of light. Thus the wavelength (i.e. colour) of light transmitted by the optical fibres (not shown) supported by the arms 12 is controlled by moving the multi-coloured filter 148 axially up or down to vary the section A-E of the filter 148 lying in an optical path between the light source 18 and a proximal end of the optical fibres.

The stepper motor 150, sleeve 152, bracket 154 and post 158 are disposed within a canister 160 located inside the cylindrical portion 28b but fixed to the shaft 40. The gear 34 is formed integrally with the canister 160.

In use, the motor 110 causing the cylindrical portion 28b to rotate about axis 28 relative to the cylindrical portion 28a, and via the transmission system 22, causes the arms 12 to rotate about their respective longitudinal axis 24. The motor 150 under the control of the controller 114 is able to vary the colour of light emitted by the optical fibres by placing different sections A-E of the multi-coloured filter 148 in the optical path between the light source 112 and the optical fibres.

In one embodiment, the multi-coloured filter can be formed with sections A, B, C and D each of one a different colour, for example section A all green, section B all blue, section C all red, and section D all yellow, with section E being multi-coloured so that it has sides E1, E2, E3, and E4 of different colour, e.g. side E1 being green, side E2 being blue, side E3 being red and side E4 being yellow.

If desired, the controller 114 may have a random rhythm control to cause the stepper motor 150 to move axially with the beat of music.

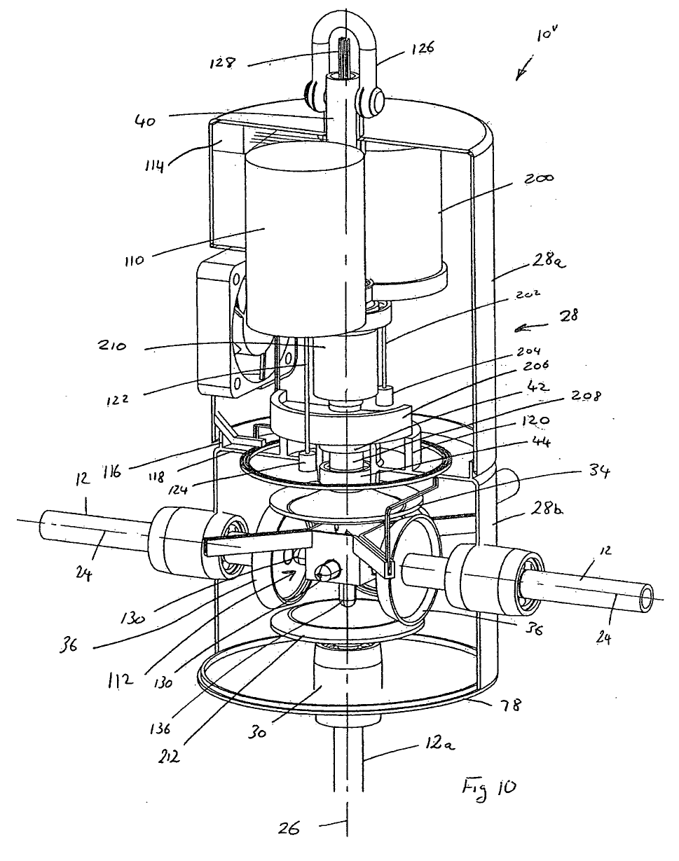

FIG. 10 depicts a fifth embodiment of the lighting apparatus 10v which is a variation on the lighting apparatus 10′″ shown in FIG. 8. The substantive difference between the embodiments of the apparatus 10″ and 10^{v} is the provision of a second motor which enables rotation of the support members 12 independent of rotation of the cylindrical portion 28b of the housing relative to cylindrical portion 28a. Another variation is the inclusion of an auxiliary support arm 12a that is rotatably coupled with and depends from lower cap 78 of the housing 28. These differences will be explained in greater detail below.

As in the embodiment of the apparatus 10″, a peripheral skirt 116 is formed on upper wall 118 of the cylindrical portion 28b and extends axially inside of a lower end of the cylindrical portion 28a. A drive element in the form of an annular wall 120 extends upright from the wall 118 and is co-axial with axis 26 of the housing 28. Motor 110 is rotationally fixed to the shaft 40 within the upper portion 28a of the housing 28 and rotates its corresponding shaft 122 to which is attached wheel 124 that contacts an outer surface of the wall 120. Thus, when the motor 110 is energised, it turns shaft 122, and wheel 124 imparting rotational drive to the wall 120 causing it and the second portion 28b of the housing 28 to rotate relative to the portion 28a about the axis 26.

The apparatus 10^{v} also includes a second motor 200 fixed to the shaft 40 within the upper portion 28a. The motor 200 comprises a shaft 202 with a wheel 204 attached to its distal end. The wheel 204 is in contact with and imparts drive to a further drive element in the form of annular wall 206 and is directly coupled by a shaft 208 to the first gear 34. A rotational coupling 210 rotationally couples the shaft 208 to the shaft 40 thereby enabling the shaft 208 and annular wall 206 to rotate about axis 26 relative to the shaft 40.

The lighting system 112 of the apparatus 10v is largely the same as the lighting system 112 described in relation to the apparatus 10″ above with the exception that the LED 136 is a multi-coloured LED similar to the LEDs 130. The auxiliary arm 12a extends from the cap 78 co-axial with the axis 26 and is held by bearings within a bush 30 formed integrally with the cap 78. A third gear 212 is coupled to a proximal end of the arm 12a and meshes with the second gears 36.

Signals to power and control the motors 110 and 200, the light system 112 and controller 114 is fed via wires 128 that enter the housing 28 through the shaft 40. When the wires provide control signals for the motors 110 and 200 and the light system 112, they can be connected to a standard DMX console enabling an operator to control the speed of rotation and states (ON and OFF) of motors 110 and 200 as well as the wavelength of light emitted by the apparatus 10^{v}.

When the motor 200 is energised, the wheel 204 rotates causing the annular wall 206 to rotate. As this wall is directly coupled to the shaft 208, this causes rotation of the first gear 34. Since the gear 34 meshes with the gears 36, the arms 12 are caused to rotate about their respective longitudinal axes 24. Additionally, due to the meshing of gear 212 with the gears 36, the arm 12a also rotates about its longitudinal axis which is coincident with the second axis 26. Due to the bearings 42 and 44 which are mounted on the shaft 208, the energising of the motor 200 does not impart torque and therefore does not rotate the housing portion 28b.

When motor 110 is energised, drive is imparted via the shaft 122 and wheel 124 to the annular wall 120 causing the housing portion 28b to rotate about axis 26 relative to the housing portion 28a. If the gear 34 is held stationary relative to the housing 28b, then in this rotation of the housing 28b will also cause rotation of the arms 12 and 12a about their respective longitudinal axis. The gear 34 may be held stationary by ensuring that the motor 200 is de-energised. In this event, the motor 200 acts as a brake on the annular wall 206 holding the wall 206 and consequently the shaft 208 and gear 34 stationary. However, in an alternate operation, if the motor 200 is operated at an appropriate speed so that the gear 34 rotates about the axis 26 at the same speed as the housing 28b, the gear 34 will in effect remain stationery relative to the gears 36 and 212 in which case, the housing 28b will rotate about axis 26 while the support members or arms 12a and 12b will not be caused to rotate about their respective axes.

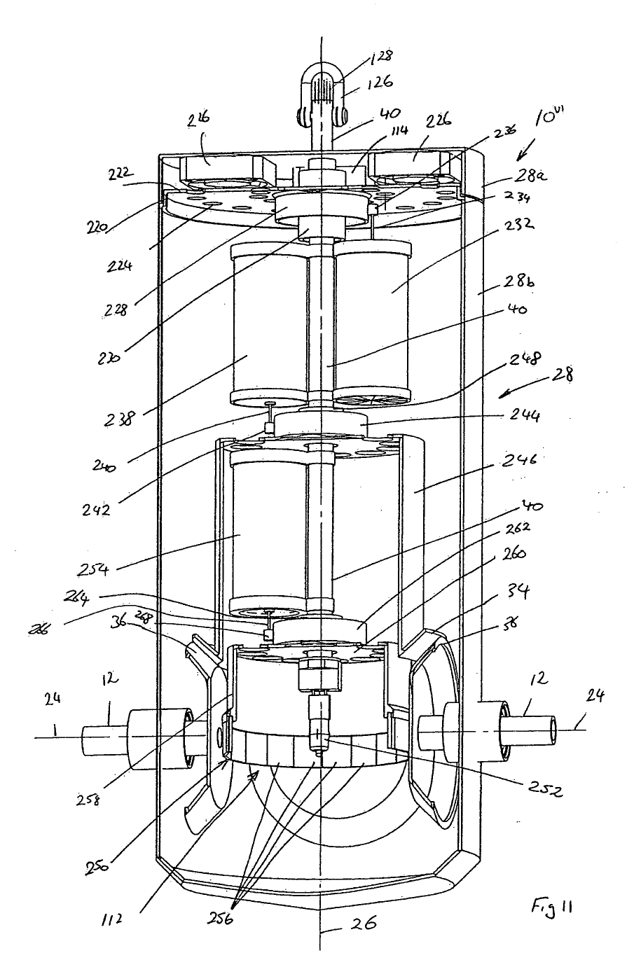

FIG. 11 depicts a further embodiment of the lighting apparatus 10^{v1}. The apparatus 10^{v1} comprises a housing 28 composed of an upper part or portion 28a which is rotationally fixed to a central shaft 40 and a second co-axial portion 28b which is able to rotate relative to the portion 28a. The shaft 40 extends along the axis 26 into the portion 28b. The portion 28b has a reduced diameter portion 220 that extends axially inside of the upper portion 28a, and an upper radial wall 222 that partitions the first part 28a from the second part 28b. The wall 222 is provided with a plurality of ventilation holes 224. Cooling fans 226 are housed within the portion 28a for blowing air into the portion 28b. An annular wall 228, similar to the annular wall 120 in the embodiments 10′″ and 10v depends from the wall 222 co-axial with the axis 26. A bush 230 is rotatably held on the shaft 40 and extends through the wall 222 to allow rotation of the portion 28b relative to the portion 28a. Motor 232 is fixed to the shaft 40 within the portion 28b and is provided with a shaft 234 having a wheel 236 at one end that engages the wall 228. When the motor 232 is energised, the shaft 234 and wheel 236 rotate. This causes the wall 228 to rotate about the axis 26 thereby rotating the portion 28b relative to the portion 28a.

A second motor 238 is attached to the shaft 40 opposite the motor 232 and is provided with a drive shaft 240 with a drive wheel 242 at its distal end. The wheel 242 engages a drive element in the form of annular wall 244. The wall 244 is attached to a cylindrical housing 246 which is provided at its lower end with the first gear 34. Wall 244 is rotatably mounted on the shaft 40 via an intervening bearing 248. The gear 34 meshes with gears 36 that are attached to the proximal ends of the support members 12. Therefore, when the motor 238 is energised, the drive element 244, cylindrical housing 246 and gear 34 rotate about the axis 26. Due to the meshing 34 with the gears 36, this causes the members 12 to rotate about their respective longitudinal axes 24.

The light system 112 in the apparatus 10^{v1} comprises an annular or cylindrical filter 250, a light bulb 252 supported centrally within the filter 250 via the shaft 40, and a motor 254. The filter 250 comprises a plurality of panels 256 formed adjacent each other in a ring. The panels 256 can be arranged to filter different wavelengths of light emitted from the light bulb 252. Any different configuration of panels are possible. For example, the panels may be arranged so that for any particular rotational position of the filter 250 relative to the arms 12, the same coloured filter may be presented between each of the arms 12 and the light bulb 252; or, a different colour filter may be presented between each support member 12 and the light bulb 252; or, for some rotational positions of the filter 250 relative to the support members 12, the same colour filter panel 256 can be presented between the bulb 252 and all of the arms 12, and for other positions different colour filter panels 256 can be presented between the different arms 12 and the light bulb 252. For example, say the filter 250 is divided into twenty panels 256. A nominal first panel may be a red coloured filter panel and each fifth panel thereafter be a red coloured filter panel. The second panel could be a yellow coloured filter panel and every fifth panel thereafter also a yellow coloured filter panel. This can be repeated for a third and fourth blue and green panels 256. A fifth panel can be any colour for example orange and each fifth panel thereafter be a different colour for example purple, pink and gold.

The filter 250 is supported at an axial end of a shroud 258 having a radial end wall 260 from which extends an annular drive element or wall 262. The shroud 258 is rotatably mounted on the shaft 40 via a bearing 264 that sits inside the annular wall 262. The motor 254 has an output shaft 266 having a drive roller or wheel 268 at one end that engages the wall 262.

When the motor 238 is energised it causes the annular wall 242 and thus the gear 34 to rotate about axis 26. Since the gear 34 meshes with the gears 36, this causes rotation of the support members or arms 12 about their respective axis 24. If the motor 232 is de-activated during this time, then the housing portion 28b remains stationary and thus the support members 12 do not rotate about axis 26.

The colour of light emitted by the optical fibre strands housed within the support members 12 while the motor 238 is energised and the motor 232 is de-energised is dependent on the rotational position of the filter 250 relative to the support members 12. This rotational position can be varied by operation of the motor 254. If the motor 254 is de-energised the colour of light emitted will not change. However when the motor 254 is energised, the wall 262 and thus the shroud 285 and filter 250 rotate about axis 26 relative to the support members 12. Accordingly as each different panel 256 comes between the respective support members 12 and the light bulb 252, different coloured light is emitted via the optical fibre strands.

When the motor 232 is energised and the motor 238 is de-energised the housing portion 28b rotates about axis 26 relative to the portion 28a. This causes the arms 12 to rotate about the axis 26. Additionally, due to the meshing of the gear 34 with the gears 36, as the housing portion 28b rotates about axis 26, the gears 36 and corresponding members 12 are caused to rotate about axis 24. Thus in this instance, there is a compound motion where the support members 12 rotate about the respective axes 24 and the second axis 26. If the motor 254 is rotated at the same speed as the motor 232, there is in effect no relative motion between the filter 250 and the housing portion 28b in which case the colour of light emitted through the optical fibre strands housed within each support member 12 remains unchanged. However by speeding up or slowing down the motor 254 for a short period of time relative to the motor 232, the rotational position of the filter 250 and thus the panels 256 relative to the portion 28b can be varied to change the colour of light emitted by the optical fibre strands. Alternately the motor 254 can be run for extended periods of time at a speed different to motor 232 to provide continuously changing light colour.

The controllers 114 of the apparatus 10^{v} and 10^{v1} can be remotely controlled to enable control of the respective motors and light systems 112 by connection to a remote device such as a DMX standard network lighting console. Alternately the remote control may be via a hand-held transmitter as discussed above in relation to the embodiment 10″.

Now that an embodiment of the invention has been described in detail it will be apparent to those skilled in the relevant arts that numerous modifications and variations may be made without departing from the basic inventive concepts. For example, any number of arms 12 can be used in the lighting apparatus 10. Additionally, while the strands 14 are illustrated as emanating from the arms 12 at two (FIGS. 1 & 2) or three (FIG. 7) different locations, further groups of strands can be provided so as to emanate from more locations along the arms 12. If desired, the arms 12 can be made from a transparent or translucent material so that light passing along the optical fibre strands can be visualised along the arms 12. Additionally, any type of gearing arrangement or other drive arrangement can be provided for imparting motion to the arms 12.

Further possible modifications and variations include making different arms 12 of different length and/or different strands 14 of different length. In addition, a heat sensor/power shut off circuit can be provided within the housing 28 to shut off power to the light 18 or lighting system 112 if the temperature within the housing 28 exceeds a nominal value. Ventilation holes (not shown) can be provided within the housing 28 to assist in dissipation of heat from within the housing 28.

The filter 54 can be configured in many different ways. For example, the filter can be split up into four quadrants each of which filters a different wavelength of light, for example red, blue, green, yellow. Alternately, the filter can be segmented into a large number (for example, sixteen) axial bands which alternate in two or more colours.

Also, an adjustable gearbox or other gear train can be provided coupling the holder 58 to the gear 74 to allow adjustment of the rate of rotation of the filter 54 relative to the arms 12.

All such modifications and variations together with others that would be obvious to a person of ordinary skill in the art are deemed to be within the scope of the present invention the nature of which is to be determined from the above description and the appended claims.

1. A lighting apparatus comprising:
a light system producing light of remotely controllable variable wavelength;
a controller coupled to said light system which receives signals from a remote device to vary the wavelength of light emitted by said light system;
at least one support member;
a housing containing said light system and to which said at least one support member is rotatably coupled;
a plurality of optical fibre strands supported by respective support members, each strand having a proximal end receiving light from said light system and a length at a distal end extending from its respective support member;
a motor supported by said housing; and,
a transmission system for imparting motion to said support members from said motor to cause said support members to rotate about one or both of respective first axes that extend collinearly with the length of each of said support members and a common second axis, said second axis being non-coincident with at least one of said first axis.

2. The apparatus according to claim 1 wherein said light system further comprises a plurality of multi-coloured light emitting devices which, when in an ON condition emit light having one of a plurality of wavelengths.

3. The apparatus according to claim 2 wherein each light emitting device is a multi-coloured light emitted diode.

4. The apparatus according to claim 1 wherein said light system comprises:
a light source;
a multi-coloured filter through which light from said light source must pass prior to entering said optical fibre strands, said multi-coloured filter having a plurality of sections which filter different wavelengths of light; and,
a positioning motor for positioning selected sections of said multi-coloured filter in an optical path between said light source and said optical fibre strands.

5. The apparatus according to claim 4 wherein said sections are arranged so that the filtered wavelength of light entering all of said optical fibre strands is the same.

6. The apparatus according to claim 4 wherein said sections of said multi-coloured filter are arranged so that at any time the filtered wavelength of light entering at least two of said optical fibres is different.

7. The apparatus according to claim 4 wherein said multi-coloured filter comprises a shroud within which said light source is disposed.

8. The apparatus according to claim 1 wherein said housing comprises first and second parts which can rotate relative to each other wherein said motor is disposed in said first part and said lighting system is disposed in said second part.

9. The apparatus according to claim 8 wherein said first part is rotationally fixed and said second part comprises an annular wall engaged by said motor to rotate said second part relative to said first part.

10. The apparatus according to claim 1 wherein the motor is a first of first and second motors and the housing comprises first and second parts that can rotate relative to each other, the first and second motors being independently controlled, the first motor providing drive through the transmission system to rotate the support members about their first axes, and the second motor providing drive through the transmission system to rotate the second part of the housing relative to the first part of the housing.

11. The apparatus according to claim 10 wherein the transmission system comprises a first gear and respective second gears coupled to each of the support members, the first gear meshing with each of the second gears and wherein the first motor, when in an energised state, imparts drive to the first gear to cause the support m embers to rotate about their respective first axes.

12. The apparatus according to claim 11 wherein the transmission system comprises a drive element coupled to the second part and wherein the second motor, when in an energised state, imparts drive to the drive element to cause a second part to rotate about a second axes relative to the first part.

13. The apparatus according to claim 12 wherein when the first motor is in a de-energised state the first motor rotationally fixes the first gear to the first part of the housing whereby ro5tation of the first part of the hosing relative to the second part of the housing also imparts drive to the second gears to cause the support members to rotate about both their respective first axes and the second axis.

14. The apparatus according to claim 10 further comprising a third motor supported by the housing and the light system comprises a light source, and a multi-coloured filter through which light from the light source must pass prior to entering the optical fibre strands, the multi-coloured filter having a plurality of sections which filter different wavele4ngths of light; wherein the third motor is coupled to the multi-coloured filter to position selected sections of the multi-coloured filter in an optical path between the light source and the optical fibre strands.

15. The apparatus according to claim 14 wherein the third motor has a controllably variable speed.

16. The apparatus according to claim 11 further comprising one or more auxiliary support arms, each auxiliary support arm rotationally coupled to the second part and extending in a direction parallel to the second axis, each auxiliary support arm supporting a plurality of optical fibre strands, each optical fibre strand having a proximal end receiving light from the light system and a length at a distal end extending from its respective auxiliary support member.

17. The apparatus according to claim 16 wherein the transmission system imparts drive to the auxiliary arms to cause them to rotate about corresponding respective longitudinal axes of each auxiliary arm.

18. A lighting apparatus comprising:
a light system producing light of remotely controllable variable wavelength, the light system receiving signals from a remote device to vary the wavelength of light emitted by the light system;
at least one first support member, each first support member having a longitudinal first axis;
a housing comprising first and second parts where the second part can rotate about a second axis relative to the first part, the housing containing the light system and rotatably supporting each of the first support members;
a plurality of optical fibre strands supported by respective first support members, each strand having a proximal end receiving light from the light system and a length at a distal end extending from its respective first support member; and,
first and second independently controllable motors, the first motor coupled to the first support members to impart drive to the first support members causing them to rotate about their respective first axes, and the second motor coupled to the second part of the housing to cause the second part of the housing to rotate about the second axis relative to the first part of the housing.

19. The apparatus according to claim 18 further comprising a transmission system including a first gear rotationally fixed to the first part of the housing and, respective second gears coupled to each first support member, the first gear meshing with each of the second gears whereby rotation of the second part of the housing relative to the first part of the housing causes the first support arms to rotate about their respective first axes.
